(19) United States
(12) Patent Application Publication
(10) Pub. No.: US 2014/0172555 A1
(43) Pub. Date: Jun. 19, 2014

(54) TECHNIQUES FOR MONITORING THE SHOPPING CART OF A CONSUMER

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/720,681

(22) Filed: Dec. 19, 2012

(51) Int. Cl. G06Q 30/06

(52) U.S. Cl. CPC G06Q 30/0633
USPC 705/14.49; 705/26.8

(57) ABSTRACT

A computer-implemented method is disclosed herein. The method includes the step of receiving, at a processing device of a commerce server, one or more signals from a head mountable unit associated with each of a plurality of products physically placed in a shopping cart by a consumer. The method also includes the step of identifying, with the processing device, each of the plurality of products in response to the corresponding one or more signals received from the head mountable unit. The method also includes the step of correlating, with the processing device, each of the plurality of products with a price. The method also includes the step of maintaining, with the processing device, a summation of the prices of the plurality of products. The method also includes the step of transmitting, with the processing device, the summation to the head mountable unit.

### BACKGROUND INFORMATION

1. Field of the Disclosure

The present invention relates generally to monitoring the shopping cart of a consumer. In particular, examples of the present invention are related to techniques for keeping the consumer informed of the aggregate cost of items in a shopping cart.

2. Background

Many consumers collect coupons or search through sale announcements when preparing to shop for products such as groceries, office supplies, and household wares. Coupons and sales are valuable tools to minimize the costs associated with a trip to a retail store. Budgeting is another tool. Cost-conscious consumers can collect items for a purchase in a shopping cart while attempting to adhere to a budget. However, maintaining a summation of the cost of goods in a shopping cart can significantly extend the time required for shopping. In addition, the diligence in maintaining the summation can be compromised by distractions, such as children or other consumers. The ability to maintain an accurate summation can also be compromised if a price of one or more of the desired products is not apparent.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating a head mountable unit that can be applied in some embodiments of the present disclosure.

FIG. 3 is an example block diagram illustration a commerce server that can be applied in some embodiments of the present disclosure.

FIG. 4A is an example screen shot of the display visible with the head mountable unit during shopping in some embodiments of the present disclosure.

FIG. 4B is another example screen shot of the display visible with the head mountable unit during shopping in some embodiments of the present disclosure.

FIG. 4C is another example screen shot of the display visible with the head mountable unit during shopping in some embodiments of the present disclosure.

FIG. 4D is another example screen shot of the display visible with the head mountable unit during shopping in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist a consumer in maintaining an accurate summation of the prices of products that the consumer intends to purchase. For example, a system according to an embodiment of the disclosure can include a commerce server receiving signals from a head mountable unit worn by the consumer. The head mountable unit can transmit one or more signals containing data that indicates the identity of a product that the consumer intends to purchase. One or more signals can be transmitted by the head mountable unit for each product.

In some embodiments of the present disclosure, the one or more signals can include a video signal in which the physical placement of a product in a shopping cart is observable. The video signals can be analyzed to determine the identity of the product. In some embodiments of the present disclosure, the one or more signals can include a video signal in which the hand of a consumer grasping a product in a shopping cart is observable and can also include an audio signal originating from the consumer, such as the vocal sound “buying this.” The audio signal can allow an exemplary system from distinguishing between a product that is merely considered for purchase and a product that the consumer intends to purchase.

In some embodiments of the present disclosure, the field of possible products shown in the video signal can be narrowed in response to the position of the consumer within a retail store. The position of the consumer can be contained in a position signal emitted by the head mountable unit and received by the commerce server. The field of possible products shown in the video signal can be narrowed in response to the direction that the consumer is facing. The direction that the consumer is facing can be contained in a position signal emitted by the head mountable unit and received by the commerce server. The data contained in various kinds of signals can be assessed in conjunction with data related to the floor plan of the retail store and the locations of products within the retail store to narrow the field of possible products shown in the video signal.

As products are accumulated by the consumer, some embodiments of the present disclosure can maintain a summation of the prices of the products in the shopping cart. The summation can be transmitted to the head mountable unit and displayed on a display of the head mountable unit. The summation can be displayed continuously or intermittently. The summation can also be transmitted as an audio signal and be played by a speaker of the head mountable unit.

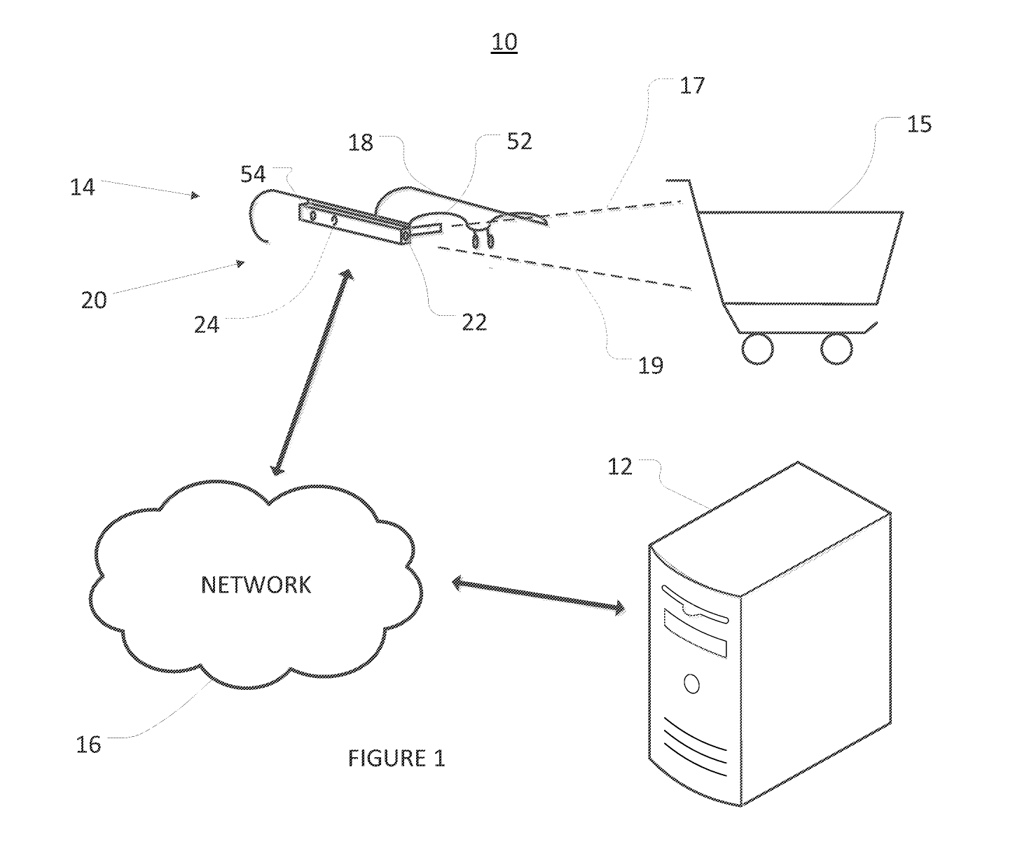

To illustrate, FIG. 1 is a schematic illustrating a cart summation system 10 according to some embodiments of the present disclosure. The cart summation system 10 can implement a computer-implemented method that includes the step of receiving, at a processing device of a commerce server 12, one or more signals from a head mountable unit 14. The one or more signals are associated with each of plurality of products placed in a shopping cart 15 by a consumer. For example, a video signal can be transmitted in which the shopping cart 15 is the field of view of a camera 22 of the head mountable unit 14. The field of view of a camera 22 is illustrated schematically by dashed lines 17 and 19. The camera 22 can capture images of products being consecutively placed in the shopping cart 15.

The one or more signals from the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The head mountable unit 14 can be worn by a consumer while moving within a retail store. In the illustrated embodiment of FIG. 1, the exemplary head mountable unit 14 includes a frame 18 and a communications unit 20 supported on the frame 18.

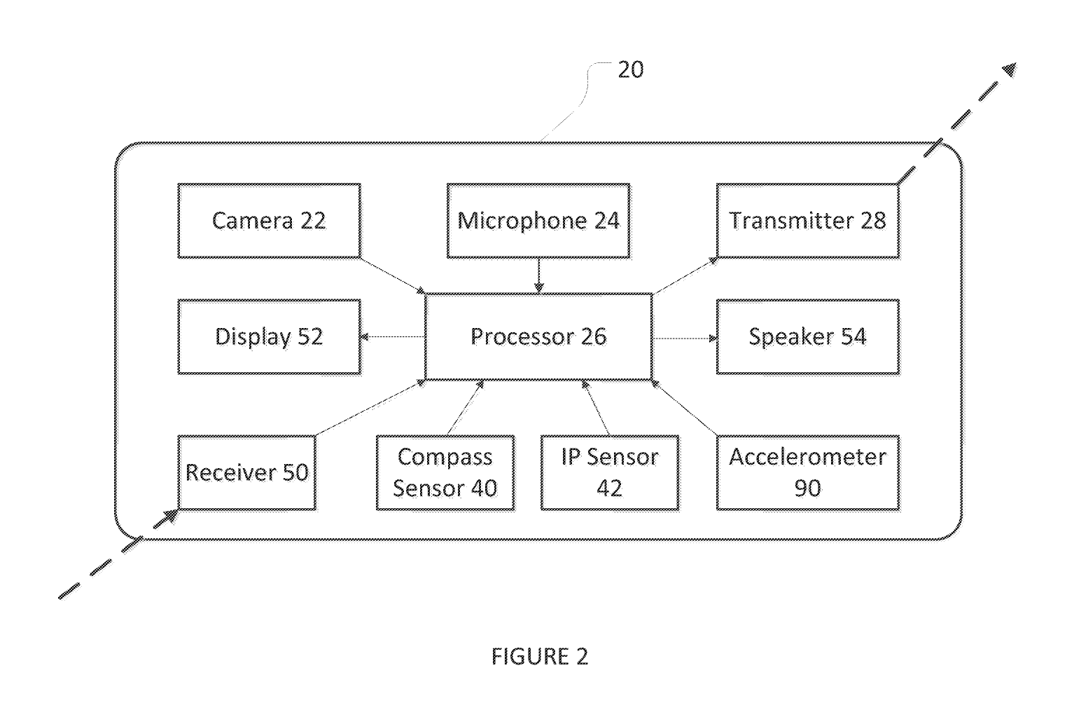

Referring now to FIG. 2, a block diagram illustrating exemplary components of the communications unit 20 includes the camera 22 configured to generate a video signal that corresponds to the field of view of the consumer wearing the head mountable unit 14. The video signal can be processed to assist in determining one or more products that the consumer is holding or placing in the shopping cart 15. It is noted that the term “shopping cart” as used herein includes carts, baskets, bags, or any other structure operable to hold products for a consumer during shopping. The communications unit 20 can also include a microphone 24 configured to generate an audio signal that corresponds to sound generated by and/or proximate to the consumer. The audio signal can be processed to assist in determining one or more products that the consumer has decided to purchase. The communications unit 20 can also include a processor 26 operable to receive signals generated by the other components of the communications unit 20. The processor can also be operable to control the other components of the communications unit 20 and also to process signals received by the head mount unit 14.

The communications unit 20 can also include a transmitter 28 configured to transmit signals generated by the other components of the communications unit 20 from the head mountable unit 14. The communications unit 20 can also include a compass sensor 40 configured to generate an orientation signal that is indicative of the direction that the consumer is facing. The direction signal can be processed to assist in determining one or more products that the consumer is accumulating for purchase.

The communications unit 20 can also include an indoor positioning sensor 42 configured to generate a position signal indicative of the position of the consumer within the retail store. The position signal can be processed to assist in determining one or more products that are proximate to the consumer. Positioning can be accomplished by radio, ultrasound, infrared, or any combination thereof. The communications unit 20 can also include a receiver 50 configured to receive signals and direct received signals to the processor 26 for further processing. The communications unit 20 can also include a display 52 configured to display text, graphics, images, illustrations and any other video signals to the consumer.

The communications unit 20 can also include a speaker 54 configured to emit sounds, messages, information, and any other audio signal to the consumer. The communications unit 20 can also include an accelerometer 90 configured to generate an acceleration signal indicative of the motion of the consumer. The acceleration signal can be processed to assist in determining if the consumer has slowed or stopped, tending to indicate that the consumer is selecting one or more products for purchase.

The camera 22 is operable to capture single images and/or video and to generate a video signal based thereon. The video signal can correspond to the field of view of the consumer wearing the head mountable unit 14. The microphone 24 (shown in phantom) is operable to capture audio data and generate an audio signal based thereon. The audio signal can correspond to sounds that are proximate to the consumer, including the voice of the consumer wearing the head mountable unit 14.

The processor 26 is operable to receive the video signal from the camera 22 and the audio signal from the microphone 24. While one processor 26 is illustrated, it should be appreciated that the term “processor” can include two or more processors that operate in an individual or distributed manner. The transmitter 28 can be an electrical communication element within the processor 26. In one example, the processor 26 is operable to direct the video and audio signals to the transmitter 28 and the transmitter 28 is operable to transmit the video signal and/or audio signal from the head mountable unit 14, such as to the commerce server 12 through the network 16.

The compass sensor 40 can be configured to sense the orientation of the consumer, such as the direction that the consumer wearing the head mountable unit 14 is facing. The compass sensor 40 can electrically communicate an orientation signal containing orientation data to the processor 26 and the processor 26 can control the transmitter 28 to transmit the orientation signal to the commerce server 12 through the network 16.

The indoor positioning sensor 42 can be configured to detect an absolute or relative position of the consumer wearing the head mountable unit 14. The indoor positioning sensor 42 can electrically communicate a position signal containing position data to the processor 26 and the processor 26 can control the transmitter 28 to transmit the position signal to the commerce server 12 through the network 16.

The receiver 50 can be operable to receive transmissions from the network and then communicate the transmissions to the processor 26. The receiver 50 can be an electrical communication element within the processor 26. In some embodiments of the present disclosure, the receiver 50 and the transmitter 28 can be an integral unit.

The display 52 can be positioned within the consumer's field of view. Video content can be shown to the consumer with the display 52, such as the summation of prices of the products to be purchased by the consumer. The summation can be transmitted by the commerce server 12, can be received by the receiver 50, and can be communicated to the processor 26. The processor 26 can then control the display 52 to show the product price summation. The display 52 can be a transparent when not in use and partially transparent when in use to minimize the obstruction of the consumer's field of view through the display 52.

The speaker 54 can be positioned within the consumer's range of hearing. Audio content transmitted by the commerce server 12 can be played for the consumer through the speaker 54. The summation can be transmitted as an audio signal and can be received by the receiver 50. The receiver 50 can receive the audio signal from the commerce server 12 and direct the audio signal to the processor 26. The processor 26 can then control the speaker 54 to emit the audio content containing the summation.

The accelerometer 90 can be a sensor that is operable to detect the motion of the consumer wearing the head mountable unit 14. The accelerometer 40 can generate an acceleration signal based on the movement that is detected and communicate the signal to the processor 26. The motion that is detected can be the acceleration of the consumer and the processor 26 can derive the velocity of the consumer from the acceleration.

In some embodiments of the present disclosure, a head mountable unit can include other features to generate signals corresponding to a product being placed in the shopping cart of a consumer. For example, a head mountable unit could include more than one camera and transmit stereo video signals for depth calculations. In some embodiments, a head mountable unit could include a camera with a convex lens. Alternative embodiments of a head mountable unit could include other sensors that generate signals that can be processed to determine when items are placed in a shopping cart, such as an infrared proximity sensor and eye tracking cameras. An infrared proximate sensor, for example, might be used to optimize how much data is being sent to the commerce server; data transmission to the commerce server 12 can be held if the infrared proximate sensor is not detecting a product proximate to the head mountable unit 14.

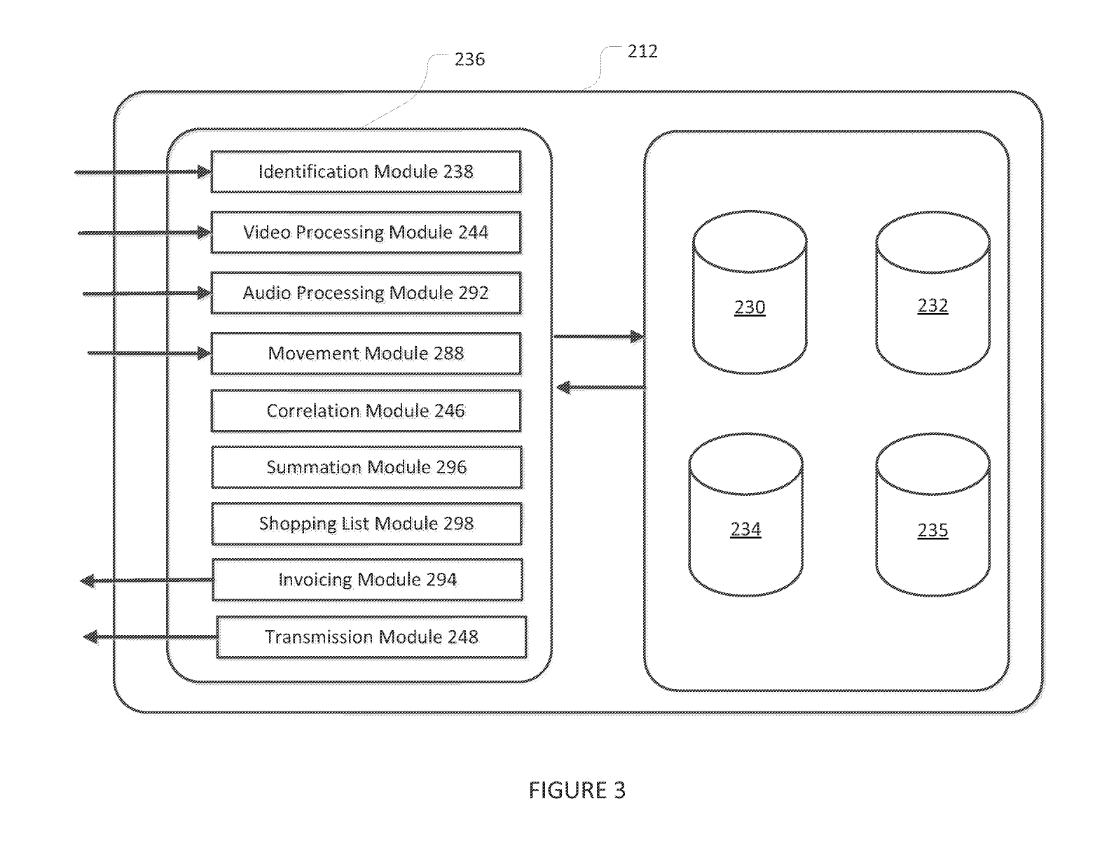

FIG. 3 is a block diagram illustrating a commerce server 212 according to some embodiments of the present disclosure. In the illustrated embodiment, the commerce server 212 can include a product database 230, a price database 232, a consumer purchase history database 234, and a product promotion database 235. The commerce server 212 can also include a processing device 236 configured to include an identification module 238, a video processing module 244, a correlation module 246, a transmission module 248, a movement module 288, an audio processing module 292, an invoicing module 294, a summation module 296, and a shopping list module 298.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The product database 230 can include memory containing the identities of a plurality of products. The plurality of products can be the products offered for sale in a retail store associated with the commerce server 212. The product database 230 can also contain a floor plan of the retail store, including the location of each of the plurality of products within the retail store. The product database 230 can also contain image data for each of the products. The price database 232 can include memory containing the prices of the products offered for sale in the retail store. The data in the product database 230 and the price database 232 can be organized based on one or more tables that may utilize one or more algorithms and/or indexes.

The consumer purchase history database 234 can include memory containing purchase histories of consumers, such as a purchase history of the consumer wearing the head mountable unit 14. The data in the consumer purchase history database 234 can be organized based on one or more tables that may utilize one or more algorithms and/or indexes.

The product promotion database 235 can include memory containing product promotions associated with one or more of the plurality of products. The product promotions can be defined by video data, audio data, and/or text data. The product promotions can be located within the product promotion database 235 and can be organized based on one or more tables that may utilize one or more algorithms and/or indexes.

The processing device 236 can communicate with the databases 230, 232, 234, 235 and receive one or more signals from the head mountable unit 14. The processing device 236 can include computer readable memory storing computer readable instructions and one or more processors executing the computer readable instructions.

The identification module 238 can be operable to receive the one or more signals from the head mountable unit 14. In some embodiments, the identification module 238 can receive a video signal from the camera 22 of the head mountable unit 14. The processing device 236 can also include a video processing module 244 operable to function cooperatively with the identification module 238 and analyze the video signal received from the head mountable unit 14. The video processing module 244 can determine if a product is being placed in the shopping cart 15.

After determining that the product is being placed in the shopping cart 15, the video processing module 244 can implement known video recognition/analysis techniques and algorithms to identify the product shown in the video signal received from the head mountable unit 14. For example, the product database 230 can also include image data associated with each of the plurality of products in the retail store. The video processing module 244 can be operable to search the data in the product database 230 and identify the product being purchased by the consumer.

In some embodiments, the determination of the product being purchased can be enhanced by analyzing other signals emitted by the head mountable unit 14. The orientation signal can be generated by the compass sensor 40 and transmitted by the head mountable unit 14 to the identification module 238. The orientation signal can correspond to a forward-facing direction of the consumer. The forward direction of the consumer can be a factor applied to narrow the set of possible products being purchased by the consumer. For example, the identification module 238 can search the data in the product database 230 indicating the locations of products in the retail store and narrow the set of possible products to products in the forward direction of the consumer.

The identification module 238 can also receive the position signal from the head mountable unit 14. The position signal can be generated by the indoor positioning sensor 42 and contain data corresponding to a location of the head mountable unit 14 in the retail store. The position of the consumer can be a factor applied to narrow the set of possible products being purchased by the consumer. For example, the identification module 238 can search the data in the product database 230 indicating the locations of products in the retail store and narrow the set of possible products to products that are proximate to the consumer. Proximate products can be products immediately in front of the consumer or, products within the field of view of the consumer. Products outside of this range, but forward of the head mountable unit 14, can be dismissed by the identification module 238. For example, products that are in adjacent aisles or further away can be dismissed by the identification module 238. The orientation and position signals can be received consecutively or concurrently by the processing device 236.

The processing device 236 can also include a correlation module 246 operable to correlate each of the one or more products placed in the shopping cart with a price from the price database 232. After the identification module 238 has identified the product being purchased by the consumer, the correlation module 246 can search the data in the price database 232 and locate the price of the product identified as being purchased by the consumer.

In some embodiments, the correlation module 246 can also be operable to correlate one or more signals receive from the head mountable unit 14 with data in the purchase history database 234. The processing device 236 can include an audio processing module 292. The microphone 24 of the head mountable unit 14 can receive audio signals that can then be transmitted to the processing device 236. The audio processing module 292 can implement known speech recognition techniques to identify speech in the audio signal, such as a voice message indicating the identity of the consumer. The correlation module 246 can search the purchase history database 234 in response to the identity of the consumer determined by the audio processing module 292. The purchase history can be applied in some embodiments as a factor applied to confirm the identity of a product being purchased by the consumer.

In some embodiments, the audio processing module 292 can also be operable process voice commands from the consumer. For example, the consumer can audibly indicate that a product, such as a product visible in the video signal being processes by the video processing module, is being purchased. In such embodiments, the processing of video signals containing the product (to determine the identity of the product) can be held until an audio signal containing a command from the consumer is received from the head mountable unit 14.

The processing device 236 can also include a summation module 296. The summation module 296 can maintain the sum of all products placed in the shopping cart 15. In some embodiments, the summation module 296 can also maintain a purchasing list containing all of the products placed in the shopping cart 15.

The processing device 236 can also include a transmission module 248 operable to receive the summation from the summation module 296 and transmit the summation to the head mountable unit 14. The signal from the transmission module 248 can be received by a receiver 50 of the communication unit 20. The receiver 50 can electrically communicate the signal containing the summation to the processor 26. The processor 26 can control the display 52 to display the summation. In some embodiments of the present disclosure, the processor 26 can control the speaker 54 to emit an audio message communicating the summation.

The processing device 236 can include a movement module 288. The movement module 288 can receive the acceleration signal from the head mountable unit 14 corresponding to movement of the consumer about the retail store. The accelerometer 90 can electrically communicate the acceleration signal containing acceleration data to the processor 26 and the processor 26 can control the transmitter 28 to transmit the acceleration signal to the commerce server 212 through the network 16. Other aspects of movement can be sensed and communicated to the movement module 288 of the processing device 236, such as velocity. In some embodiments, the position data generated by the indoor positioning sensor 42 can be processed by the movement module 288 to determine the consumer's movement. The processing executed by the identification module 238 and the video processing module 244 can be held until the movement module 288 determines that the consumer has substantially stopped moving, indicating that the consumer has reached a product of interest.

In some embodiments, the correlation module 246 can also be operable to correlate one or more signals receive from the head mountable unit 14 with data in the product promotion database 235. After the product being purchased has been identified by the identification module 238, the correlation module 246 can correlate the product being purchased to at least one product promotion in the promotion database 235. For example, if the consumer is purchasing tortilla chips, the correlation module 246 correlate the tortilla chips to a product promotion for salsa. The product promotion can be a form of electronic file that includes video, audio, graphic, and/or text data. The transmission module 248 can transmit the product promotions correlated to the product being purchased to the head mountable unit 14. The processor 26 can receive the signal from the transmission module 248 and display the product promotion through the display 52 and/or through a speaker 54.

The processing device 236 can also include an invoicing module 294. Upon the transmission module 248 sending one or more product promotions, the invoicing module 294 can generate a first invoice for the manufacturer of the products that are the subject of the product promotion.

The processing device 236 can also include a shopping list module 298. In some embodiments, the consumer can communicate a list of items to commerce server 212 that will be purchased. The shopping list module 298 can direct a query to the consumer at the onset of shopping through the transmission module 248. The query can prompt the consumer to recite products that the consumer desires to purchase at the retail store. The vocal sounds emitted by the consumer can be processed by the audio processing module 292. The audio processing module 292 can cooperatively function with the shopping list module 298 to convert the vocal sounds emitted by the consumer into a digital shopping list maintained by the shopping list module 298. The shopping list module 298 can cooperatively function with the summation module 296 to compare the shopping list maintained by the shopping list module 298 with the purchasing list shopping list maintained by the summation module 296 as the consumer shops to advise the consumer of any discrepancies between the two lists.

It is noted that in some embodiments, the processor 26 on the head mountable unit 14 could modify the video stream to something else that requires less bandwidth. For example, the processor 26 could convert a video signal containing color to black and white video. In some embodiments, the processor 25 could crop the video, or sample the video and display frames of interest. A frame of interest could be a frame that is significantly different from other frames, such as a generally low quality video having an occasional high quality frame. Thus, in some embodiments, the processor 26 could selectively extract video or data of interest from a video signal containing data of interest and other data.

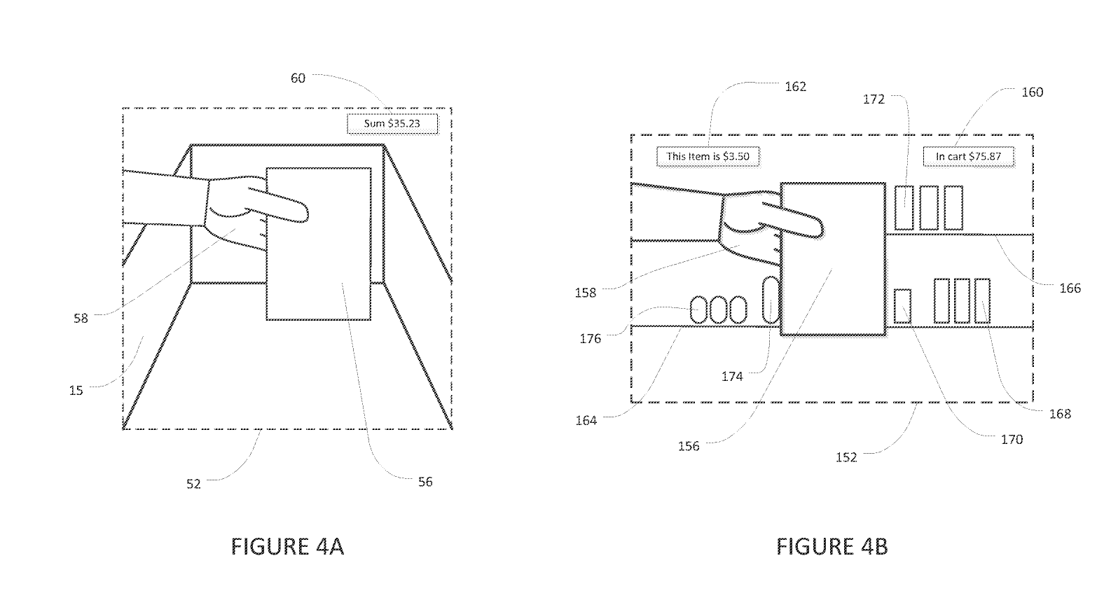

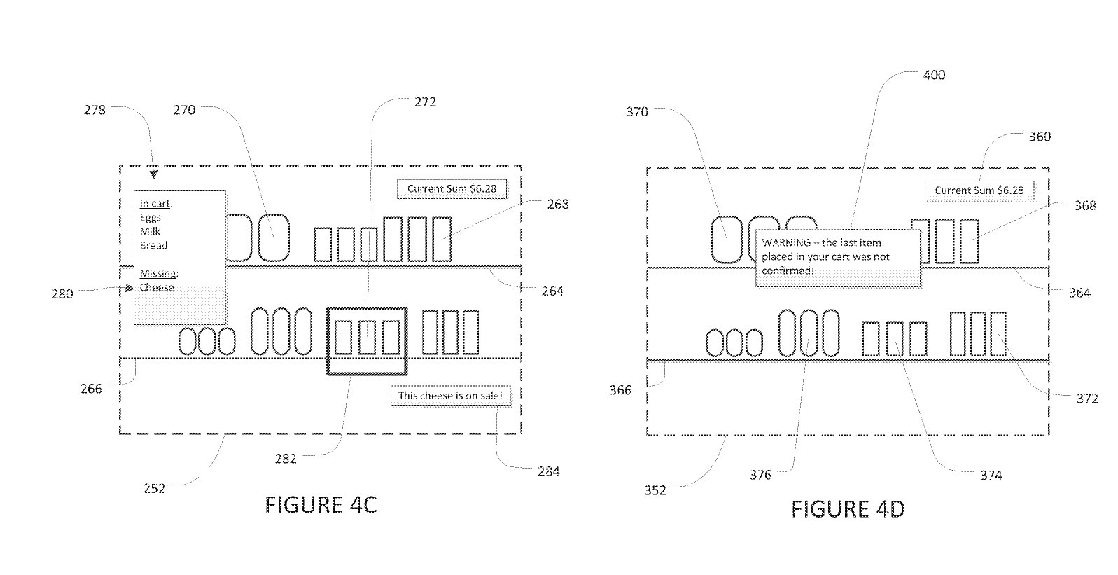

FIGS. 4A-4B illustrate views that can be perceived by the consumer and by the video processing module 244 in some embodiments of the present disclosure. The camera 22 and display 52 of the head mountable unit 14 can be generally aligned such that the display 52 overlaps the field of view of the camera 22. In other words, the camera 22 is arranged so that the video signal received by the commerce server 212 is substantially similar to the field of view through the display 52 for the consumer wearing the head mountable unit 14.

FIG. 4A is a screen shot of a field of view that can be visible to the consumer and also received as a video signal by the video processing module 244. The screen shot can fill the display 52 or can be a portion of the display 52. The consumer can be looking through at least part of the display 52 and can view the placement of a product 56 into the shopping cart 15 by the consumer's hand 58. The video processing module 244 can process the video signal containing this event and determine that the product 56 is being purchased.

The identification module 238 can then identify the product 56 from among the products in the product database 230. The correlation module 246 can then correlate the product 56 to the price of the product 56 from the price database 232. The summation module 296 can then add the price of the product 56 to the current cost sum of products in the shopping cart 15. The transmission module 248 can then transmit the summation to the head mountable unit 14. The display 52 is operable to display the summation 60 to the consumer.

The consumer may grasp and closely examine products that are not purchased. Various embodiments of the present disclosure can distinguish between products that are merely examined from products that are purchased in various ways. For example, the video processing module 244 can recognize the video signal corresponding to the exemplary display shown in FIG. 4A as an indication that the consumer is purchasing the product 56 because the consumer's hand 58 and the shopping cart 15 are both in the field of view. Alternatively, the video processing module 244 can recognize the video signal corresponding to the exemplary display shown in FIG. 4A as an indication that the consumer is purchasing the product 56 because the consumer's hand 58 is positioned within the shopping cart 15.

FIG. 4B is a screen shot from an alternative embodiment of the present disclosure. FIG. 4B illustrates a field of view that can be visible to the consumer and also received as a video signal by the video processing module 244. The screen shot can fill the display 152 or can be a portion of the display 152. The consumer can be looking through at least part of the display 152 and view a product 156 being held by the consumer's hand 158. The display 152 is operable to display the summation 160 to the consumer. The exemplary display 152 is also operable to display a price 162 of the product 156 to the consumer. Shelves 164 and 166 supporting products 168, 170, 172, 174, 176 are visible in the background, behind the product 162.

In some embodiments of the present disclosure, a cart summation system can recognize that the consumer is purchasing the product 156 in response to both audio and video signals received from the head mountable unit 14. For example, the video processing module 244 can recognize the video signal corresponding to the exemplary display shown in FIG. 4B as an indication that the consumer is purchasing the product 156 in response to the consumer's hand 58 is grasping the product 156. However, in some embodiments of the present disclosure, the determination of the video processing module 244 can be supplemented with additional data before the commerce server 212 concludes that the product is being purchased. The consumer's intention to purchase the product 156 can be confirmed upon receipt of an audio signal in some embodiments of the present disclosure. For example, the consumer can grasp the product 156 in the field of view of the camera 22 and emit a vocal sound, such as “buying this” or “add to cart.” The audio processing module 292 can process the audio signal containing the consumer's command. The determination that a product is being purchased can thus be made in response to the operations of both the video processing module 244 and of the audio processing module 292.

In some embodiments, the placement of the item in a shopping cart may not be captured on video if the customer is looking away. However, the video signal could be processed to such that if a product appears in a consumer's hand but subsequently is not, the commerce server 212 could prompt the consumer with a video or audio message received through the head mountable unit 214 regarding the status of the product. Alternatively, the commerce server 212 could assume the product is being purchased based on a predetermined probability.

FIGS. 4C-4D illustrate views that can be perceived by the consumer and by the video processing module 244 in some embodiments of the present disclosure. In FIG. 4C, the consumer can be looking through at least part of the display 252 and viewing products, such as products 268, 270, 274, supported on shelves 264, 266. The view of FIG. 4C can be defined as the consumer is shopping, between the identification of products being purchased. The display 252 is operable to display a then-current summation 260 to the consumer.

FIG. 4C can be defined in some embodiments of the present disclosure in which the shopping list module 298 communicates the shopping list to the transmission module 248 and the transmission module 248 transmits the shopping list to the head mountable unit 14. The display 252 can display the shopping list 278 to the consumer.

FIG. 4C also illustrates that the shopping list module 298 can cooperatively function with the summation module 296 to compare the shopping list maintained by the shopping list module 298 with the purchasing list shopping list maintained by the summation module 296 as the consumer shops. A discrepancy between the two lists can be communicated to the transmission module 248 and the transmission module 248 can transmit the discrepancy to the head mountable unit 14. The display 252 can display the discrepancy 280 to the consumer.

FIG. 4C also illustrates that one or more product promotions can be delivered to the consumer and a product promotion can be correlated to a discrepancy between the shopping list and the purchasing list. The shopping list module 298, the summation module 296, and the correlation module 246 can cooperatively function with respect to one another. After the shopping list module 298 has identified a discrepancy, the shopping list module 298 can communicate the discrepancy to the correlation module 246. The correlation module 246 can correlate the discrepancy, a product, with one or more product promotions in the product promotions database 235. The one or more product promotions can be transmitted to the head mountable unit 14 by the transmission module 248. FIG. 4C illustrates a visual display associated with a product promotion that has been generated on the display screen 252. The exemplary visual display is an outline referenced at 282 around the product brand 272, as well as text referenced at 284.

In some embodiments, product promotions can be displayed for all or less than all of the brands a product that has not been purchased but is on the shopping list. The promotions can be sized differently from one another; product manufacturers can pay for the opportunity of the largest product promotion display. The product promotions can be shaped differently from one another; product manufacturers can pay for particular promotion shapes or colors. Other types of displays can be applied in some embodiments of the present disclosure.

FIG. 4D is a screen shot from an alternative embodiment of the present disclosure. FIG. 4D illustrates a field of view that can be visible to the consumer and also received as a video signal by the video processing module 244. The screen shot can fill the display 352 or can be a portion of the display 352. The consumer can be looking through at least part of the display 352 and view shelves 364 and 366 supporting products 368, 370, 372, 374, 376. The display 352 is operable to display the summation 360 to the consumer.

FIG. 4D also illustrates that some embodiments of the present disclosure can be operable to advise a consumer of a possible error in maintaining the summation. The identification module 238 and the video processing module 244 can cooperatively function with each another if, for example, the consumer places a product in the shopping cart and continues shopping before the product has been identified. If the video signal and other signals that are applied to identify the product are not sufficient to identify the product, the identification module 238 can direct a warning to the transmission module 248. The transmission module 248 can transmit the warning to the head mountable unit 14. The warning can be displayed on the display 352 of the head mountable unit 14. FIG. 4D illustrates an exemplary warning 400 on the display 352. In some embodiments of the present disclosure, the warning can be an audible warning.

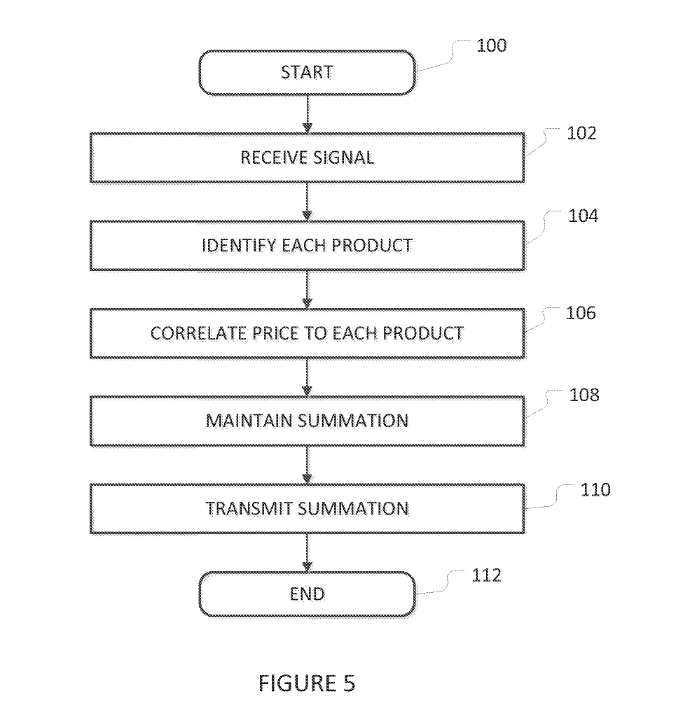

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 is a flow chart illustrating a method that can be carried out in some embodiments of the present disclosure. The method can be executed by a commerce server. The commerce server can be located at the retail store or can be remote from the retail store. The method starts at step 100. At step 102, the commerce server can receive a signal. The signal can be indicative of a product being purchased by a consumer, such as the placement of the product in a shopping cart.

At step 104, the identity of the product is obtained. At step 106, the identity of the product is correlated with the price of the product. At step 108, the price of the product can be added to the sum of products previously indicated as being purchased, such as products already positioned in the shopping cart. At step 110, the summation can be transmitted to a head mountable unit and the exemplary method ends at step 112.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
receiving, at a processing device of a commerce server, one or more signals from a head mountable unit associated with each of a plurality of products physically placed in a shopping cart by a consumer;
identifying, with the processing device, each of the plurality of products in response to the corresponding one or more signals received from the head mountable unit;
correlating, with the processing device, each of the plurality of products with a price;
maintaining, with the processing device, a summation of the prices of the plurality of products; and
transmitting, with the processing device, the summation to the head mountable unit.

2. The computer implemented method of claim 1 further comprising:
tabulating, with the processing device, a purchasing list of the plurality of products.

3. The computer implemented method of claim 2 further comprising:
establishing, with the processing device, a shopping list of products to be purchased;
determining, with the processing device, a deficiency in the purchasing list by comparing the purchasing list and the shopping list; and
transmitting, with the processing device, a signal to the head mountable unit in response to said determining step.

4. The computer implemented method of claim 3 wherein said establishing step includes:
receiving, with the processing device, an audio signal from the head mountable unit containing the shopping list.

5. The computer implemented method of claim 2 further comprising:
transmitting, with the processing device, the purchasing list to the head mountable unit.

6. The computer implemented method of claim 1 further comprising:
determining, with the processing device, that the one or more signals from a head mountable unit are unreliable;
transmitting, with the processing device, a warning signal to the head mountable unit in response to said determining step.

7. The computer implemented method of claim 1 further comprising:
correlating, with the processing device, at least one of the plurality of products with one or more product promotions for a product not disposed in the shopping cart; and
transmitting, with the processing device, the one or more product promotions to the head mountable unit.

8. The computer implemented method of claim 1 wherein said receiving step includes:
receiving, at the processing device of the commerce server, a video signal from a head mountable unit containing a video image of a product being physically placed in a shopping cart by the consumer.

9. The computer implemented method of claim 1 wherein said receiving step includes:
receiving, at the processing device of the commerce server, a video signal from a head mountable unit containing a video image of a product and an audio signal originating from the consumer.

10. The computer implemented method of claim 1 wherein said transmitting step includes:
controlling, with the processing device, a display of the head mountable unit to display the summation.

11. The computer implemented method of claim 10 wherein said transmitting step includes:
controlling, with the processing device, a speaker of the head mountable unit to emit audio containing the summation.

12. The computer implemented method of claim 1 wherein said identifying step includes:
identifying, with the processing device, each of the plurality of products in response to a respective position signal received from the head mountable unit and corresponding to a position of the head mountable unit within the retail store.

13. The computer implemented method of claim 1 wherein said identifying step includes:
identifying, with the processing device, each of the plurality of products in response to a respective orientation signal received from a compass sensor of the head mountable.

14. The computer implemented method of claim 1 wherein said identifying step includes:
identifying, with the processing device, each of the plurality of products in response to a respective acceleration signal received from an accelerometer of the head mountable unit.

15. The computer implemented method of claim 1 wherein said identifying step includes:
evaluating, with the processing device, a purchase history of a consumer wearing the head mountable unit.

16. A commerce server comprising:
a processing device operable to receive one or more signals from a head mountable unit associated with each of a plurality of products physically placed in a shopping cart by a consumer and including:
an identification module operable to identify each of the plurality of products in response to the corresponding one or more signals received from the head mountable unit;
a correlation unit operable to correlate each of the plurality of products with a price;
a summation module operable to maintain a summation of the prices of the plurality of products; and
a transmission module operable to transmit the summation to the head mountable unit.

17. The commerce server of claim 16 further comprising:
a product database containing the identities of the plurality of products and the locations of each of the plurality of products within the retail store.

18. The commerce server of claim 16 further comprising:
a price database containing the prices of the plurality of products.

19. The commerce server of claim 16 further comprising:
a purchase history database containing the a purchase history of a consumer wearing the head mountable unit.
